(19) United States
(12) Patent Application Publication
(10) Pub. No.: US 2010/0159430 A1
(43) Pub. Date: Jun. 24, 2010

(54) EDUCATIONAL SYSTEM AND METHOD USING VIRTUAL REALITY

(75) Inventors: Su Woong LEE, Daejeon (KR); Jong-Gook Ko, Daejeon (KR); Junsup Lee, Daejeon (KR); Hyung-Keun Jee, Daejeon (KR); Junsuk Lee, Daejeon (KR)

Correspondence Address: STAAS & HALSEY LLP, SUITE 700, 1201 NEW YORK AVENUE, N.W., WASHINGTON, DC, 20005, US

(73) Assignee: Electronics and Telecommunications Research Institute, Daejeon (KR)

(21) Appl. No.: 12/634,954

(22) Filed: Dec. 10, 2009

(30) Foreign Application Priority Data
Dec. 22, 2008 (KR) 10-2008-0131661

(51) Int. Cl. G09B 5/00; G09B 5/04; G09B 7/00

(52) U.S. Cl. 434/307 R; 434/308; 434/320; 434/350

(57) ABSTRACT

An educational system using virtual reality includes an image computer for extracting an image of a student from an entire image acquired by capturing the student; a remote lecturer computer for extracting an image of a lecturer at a remote place from an entire image acquired by capturing the remote lecturer. Further, the educational system using the virtual reality includes a classroom lecturer computer for executing learning content in which a virtual space is implemented, and performing real-time communication with the remote lecturer computer; and a virtual reality computer for combining the image of the student and the image of the remote lecturer with the virtual space of the learning content.

### CROSS-REFERENCE TO RELATED APPLICATIONS

The present invention claims priority of Korean Patent Application No. 10-2008-0131661, filed on Dec. 22, 2008, which is incorporated herein by reference.

### FIELD OF THE INVENTION

The present invention relates generally to an educational system and method using virtual reality; more particularly, to an educational system and method, which implement a virtual space in which students located in a classroom and a lecturer located at a remote place appear, thus supporting learning which allows the students to interact with virtual reality content while the students feel as if they were immersed in learning content.

### BACKGROUND OF THE INVENTION

Recently, the importance of an education having a basis in reality has been emphasized for the learning of foreign languages and the like. Accordingly, some public institutions provide a learning space by establishing English villages for experience-based English learning or the like. However, a lot of people cannot access the English village due to the spatial restrictions thereof. Accordingly, efforts to overcome this problem using electronic learning (e-learning) services recently introduced with the development of information communication technology, that is, remote video education and a virtual classroom enabling learning in an Internet-based virtual learning space, have been made.

However, remote video education is disadvantageous because it provides a method for learning that has only a simple format. Further, a virtual classroom has a problem in that learning is mainly conducted using an avatar rather than the student him or herself, so that it is difficult for the student to have a sense of reality or immersion as if he or she were really appearing in the virtual space. Such a conventional technology is configured such that an image of a lecturer at a remote place or an image of a student is simply projected to a preset location on a screen and such that a background is simply changed, thus making it difficult to efficiently provide virtual reality-based education having a reality.

Therefore, an educational system and method capable of providing experience-based education while overcoming spatial restrictions using computer technology are currently required.

### SUMMARY OF THE INVENTION

In view of the above, the present invention to provide an experience-based educational system and method, which implement virtual reality and provide an interface for recognizing the gestures of a user and interacting with the user, thus increasing the sense of reality of the education.

Further, the present invention provides an experience-based educational system and method, which allow a user located at a remote place and a user located in a classroom to share a single virtual world with each other without simply changing the background of a screen, thereby increasing a sense of immersion of a student in learning.

In accordance with a first aspect of the present invention, there is provided an educational system using virtual reality, including: an image computer for extracting an image of a student from an entire image acquired by capturing the student; a remote lecturer computer for extracting an image of a lecturer at a remote place from an entire image acquired by capturing the remote lecturer; a classroom lecturer computer for executing learning content in which a virtual space is implemented, and performing real-time communication with the remote lecturer computer; and a virtual reality computer for combining the image of the student and the image of the remote lecturer with the virtual space of the learning content.

In accordance with a second aspect of the present invention, there is provided an educational method using virtual reality, including: extracting an image of a student from an entire image acquired by capturing the student; extracting an image of a lecturer at a remote place from an entire image acquired by capturing the remote lecturer; executing learning content in which a virtual space is implemented, and performing real-time communication with the remote lecturer; and combining the image of the student and the image of the remote lecturer with the virtual space of the learning content.

In accordance with the present invention, it is possible to provide the educational system and method capable of providing experience-based education while overcoming spatial restrictions using virtual reality. Further, the classroom and the remote lecturer appear in the same virtual space, gestures of the student are recognized and the content is conducted, thereby increasing the sense of immersion of the student in the class.

### BRIEF DESCRIPTION OF THE DRAWINGS

The objects and features of the present invention will become apparent from the following description of embodiments given in conjunction with the accompanying drawings, in which:

FIG. 1 is a block diagram showing the construction of an educational system using virtual reality in accordance with an embodiment of the present invention;

FIG. 2 is a diagram showing an example of the educational system using virtual reality of FIG. 1;

FIG. 3 is a diagram showing the classroom of FIG. 1 in which learning content is being executed;

FIG. 4 is a diagram showing the classroom of FIG. 1 in which a student and a remote lecturer appear in the learning content of FIG. 3 and the learning is being conducted; and

FIG. 5 is a flow chart showing an educational method using virtual reality in accordance with the embodiment of the present invention.

### DETAILED DESCRIPTION OF THE EMBODIMENTS

Hereinafter, embodiments of the present invention will be described in detail with reference to the accompanying drawings which form a part hereof.

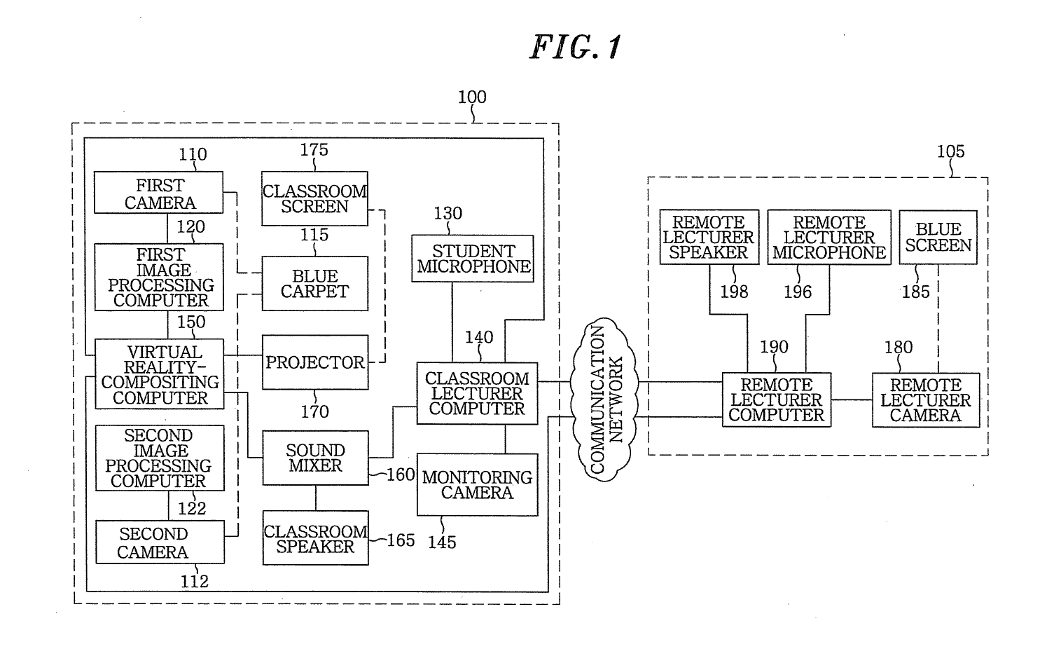

FIG. 1 is a block diagram showing the construction of an educational system using virtual reality in accordance with the embodiment of the present invention.

The educational system in accordance with the embodiment of the present invention may be operated in physically separated spaces, i.e., a classroom 100 and a remote place 105. For example, in case of foreign language education, students and a lecturer located in the classroom 100 in Korea can conduct a class with the support of a remote lecturer located at the remote place 105 by connecting the classroom 100 with the remote place 105 while conducting the class in the classroom 100.

A first student camera 110 captures an image from each student. A first image computer 120 extracts only an image of the student from the entire image captured by the first student camera. In an embodiment, a blue carpet 115 may be used to facilitate a procedure for extracting the image of the student. When the first student camera 110 captures an image from the student standing on the blue carpet 115, an advantage of facilitating the procedure for extracting only the image of the student from a background is obtained. When the student does not need to move or when it is possible to use only a two-dimensional image of the student, a blue screen instead of the blue carpet 115 may be used to allow the student to stand or sit in front of the blue screen, and thus to acquire the image of the student.

In an embodiment, the virtual reality of the present invention may be implemented using three-dimensional images. In this case, to implement a three-dimensional image of the student, two or more cameras and image computers, including a second student camera 112 and a second image computer 122, are used. The first and second cameras 110 and 112 may be implemented as a single stereo camera. The first and second student cameras 110 and 112 implemented as the stereo camera may be respectively located at the front and the back of the inside of the classroom. In this case, as learning content, three-dimensional image-based learning content may be used.

Meanwhile, a remote lecturer camera 180 captures an image of a lecturer at the remote place. A remote lecturer computer 190 extracts an image of the remote lecturer from the entire image captured by the remote lecturer camera 180. In an embodiment, a blue screen 185 may be used to facilitate a procedure for extracting the image of the remote lecturer. When the remote lecturer camera 180 captures an image from the remote lecturer standing in front of the blue screen 185, an advantage of facilitating the procedure for extracting the image of the remote lecturer from a background is obtained. When the remote lecturer needs to move or when a three-dimensional image of the remote lecturer is used, a blue carpet instead of the blue screen 185 is used to allow the remote lecturer to stand or move on the blue carpet, and thus to capture a three-dimensional image of the remote lecturer using the remote lecturer camera 180 implemented as a stereo camera or the like.

A virtual reality computer 150 implements a virtual space in which the student and the remote lecturer appear by combining images contained in the learning content, the image of the student, and the image of the remote lecturer with each other.

The learning content is created in advance, and a procedure for creating the content is divided into a raw content production operation such as three-dimensional modeling, voice recording, the production of animation, and the production of images, and a content packaging operation of positioning the raw content and defining rules reacting on various types of interaction with the student and the lecturer. The creation of learning content that can be used by the virtual reality computer 150 is completed only after the two operations have been completed.

In order to combine the images of the student and the lecturer with the images of the learning content, spatial information awareness technology is used. The virtual reality computer 150 calculates the relative locations of the first and second student cameras 110 and 112 and the bottom of the classroom to align the bottom of the real world with the bottom of the virtual world using the spatial information awareness technology, which allows the motion of the student in the real world to be naturally implemented even in the virtual world. As long as the cameras are not moved after the educational system in accordance with an embodiment of the present invention has been installed, there is no need to align the bottoms again, and thus the aligning is also performed in advance.

The operations to be performed by the virtual reality computer 150 for each frame of the camera are as follows. First, the first and second cameras 110 and 112 capture each student. The first and second image computers 120 and 122 extract images of the student and calculate the location of the world coordinates of the student using the location of the feet of the student. Further, the remote lecturer camera 180 captures the remote lecturer, and the remote lecturer computer 190 extracts an image of the remote lecturer. A three-dimensional virtual space is constructed using the extracted images of the student and the remote lecturer and other virtual objects contained in the learning content. The student and the remote lecturer share the same virtual space with each other, thus increasing the sense of reality and immersion of the student in the class.

In an embodiment, the first and second image computers 120 and 122 may be implemented to recognize the gestures of the student. A method of estimating the locations of the hands, feet or head of an object using information such as the color or motion of the image of the object may be used as a gesture recognition method. In this case, learning interaction based on the locations of the hands, feet or head of the student can be performed, and a scenario used in the learning content may be performed based on the action of the student using the results of the successive estimation of the locations of the hands, feet or head. The performance of the scenario used in the learning content is basically implemented on the basis of rules predefined by the manipulation of the classroom lecturer computer 140 of the lecturer in the classroom.

A projector 170 outputs results implemented in a three-dimensional virtual space. The projector 170 generally outputs the results on a large screen such as a classroom screen 175 depending on the characteristics of the educational system using virtual reality.

Meanwhile, a monitoring camera 145 captures a learning scene in the classroom and allows both the lecturer in the classroom and the lecturer at the remote place to monitor the progress of learning in the classroom.

In order to implement the educational system and method using virtual reality, an audio system is also required. A student microphone 130 receives the voice of the student, and a remote lecturer microphone 196 receives the voice of the remote lecturer. The classroom lecturer computer 140 processes the voice of the student, and the remote lecturer computer 190 processes the voice of the remote lecturer, respectively.

Further, learning content executed by the classroom lecturer computer 14 also contains unique voices. A sound mixer 160 mixes the voices of the learning content, the voice of the student, and the voice of the remote lecturer with each other. A classroom speaker 165 outputs the mixed voice. A remote lecturer speaker 198 outputs the voice to the remote lecturer. Here, the speaker may be implemented by one of similar sound output devices such as an earphone or a headphone.

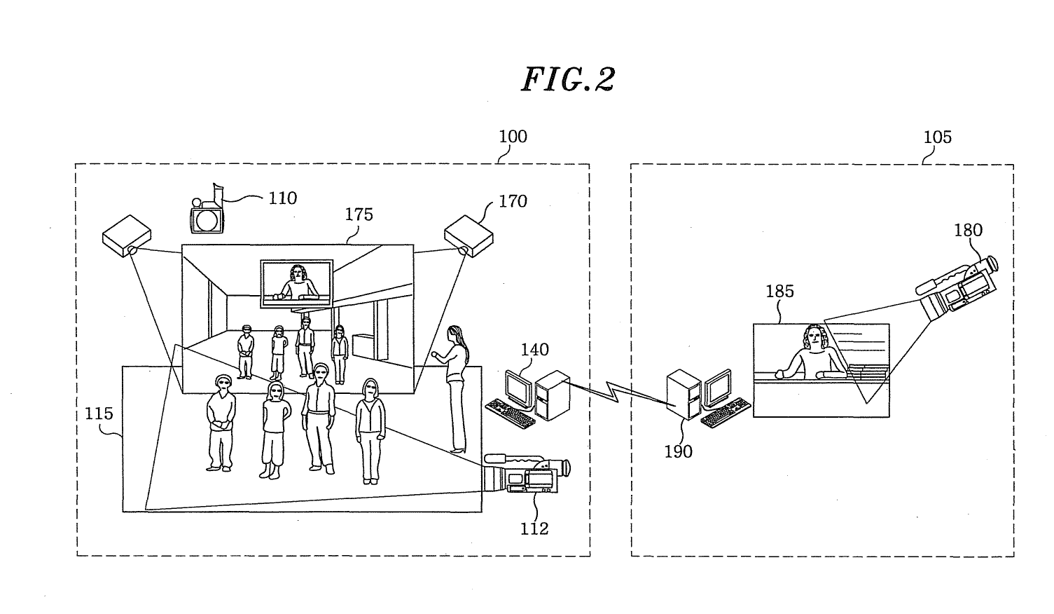

FIG. 2 is a diagram showing an example of the educational system using virtual reality of FIG. 1.

The educational system in accordance with an embodiment of the present invention includes two parts, i.e., a classroom 100 and a remote place 105. The classroom 100 is a space in which learning is conducted, and the remote place 105 is a space in which a remote lecturer supports a class.

Both a projector 170 and a large classroom screen 175 are installed at the front of the inside of the classroom 100. A virtual world is implemented on the large classroom screen 175. The virtual world includes the image of each student, the image of the native lecturer, and other virtual objects of learning content executed by a classroom lecturer computer 140. Since the virtual world is mapped to the real world, the motion of the student in the classroom 100 is mapped to the motion of the student in the virtual world without change. In an embodiment, the locations of the hands, feet or head of the student are tracked so that the gestures of the student are recognized by the system, and thus an event may be generated. For the other virtual objects constituting the virtual world, objects having animation inserted thereinto, as well as static objects, may be used, and as a result, the reality may be increased. The native lecturer at the remote place 105 can monitor a situation in the classroom using the images transmitted from a monitoring camera 145. When the native lecturer performs a certain conversion and performs a certain action in front of a blue screen 185, images corresponding to the conversation and action are captured by a remote lecturer camera 180, and are then transmitted to the student in the classroom through the classroom screen 175.

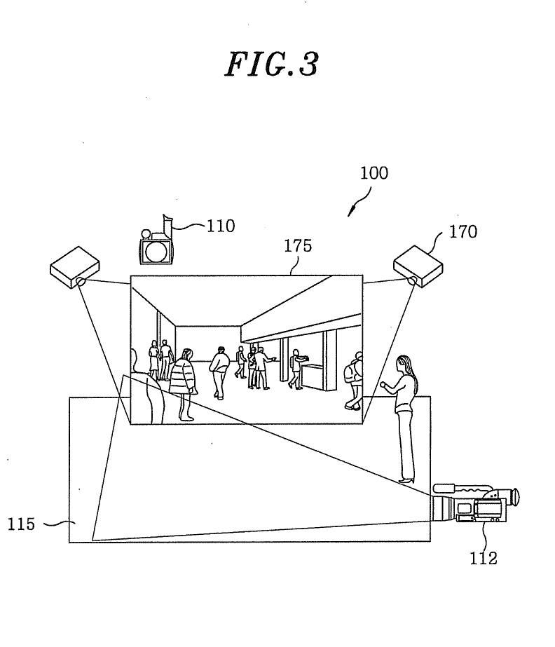

FIG. 3 is a diagram showing the classroom of FIG. 1 in which learning content is being executed.

When a lecturer in the classroom turns on the educational system in accordance with the embodiment of the present invention, the virtual space is implemented on a classroom screen 175 depending on the substance of learning content. The virtual space corresponds to the result prior to being combined with the images of a student and a remote lecturer.

Various virtual spaces may be created depending on the substance of the learning content. For example, the gate, ticket office, passersby, internal structure, and trains of the Boston subway are modeled without change, and may be implemented in the virtual world. When the student is situated in the virtual space, the student views him or herself appearing on the screen and may have an experience as if he or she were visiting the inside of the Boston subway while moving in the subway. When the remote lecturer is suitably situated in the virtual space as a ticket office worker, a police, a passerby or the like, the student can further improve his or her feeling of experience through actual conversation with the remote lecturer. The virtual space can be continuously changed by the manipulation of the classroom lecturer, and thereby the student can continuously conduct learning activities having new content while the virtual space is changing.

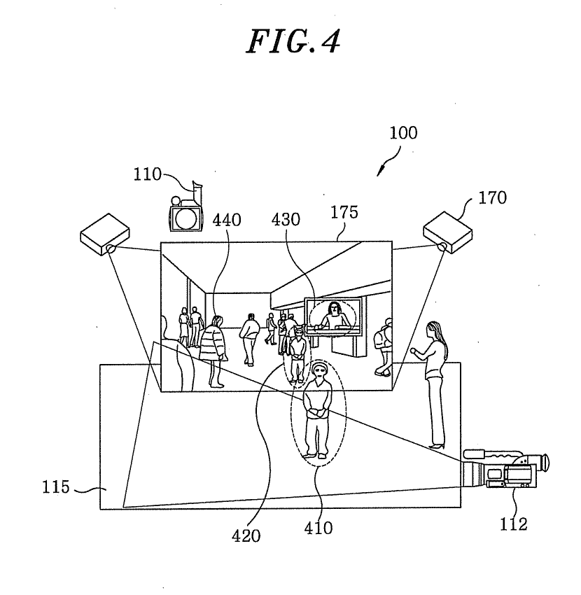

FIG. 4 is a diagram showing the classroom of FIG. 1 in which a student and a remote lecturer appear inside the learning content and a class is being conducted.

When a student 410 stands on a blue carpet 115, an image of the student 420 appears on a classroom screen 175, and avatars 440, which are virtual objects, appear on the screen by the manipulation of a classroom lecturer. The student 410 can perform a conversation with the avatars. In this case, the avatars 440 may be manipulated by the classroom lecturer. During the learning, the student 410 can proceed with his or her learning using gestures while freely moving on the blue carpet 115.

As the classroom lecturer replaces learning content, the background may change and a new scenario may be implemented. A few of the avatars 440 in the virtual space can be replaced with a native lecturer 430, and the student 410 can more freely perform a conversation with the native lecturer 430. The classroom lecturer and the remote lecturer observe the course of the class using the images transmitted from a monitoring camera 145 and can evaluate the student.

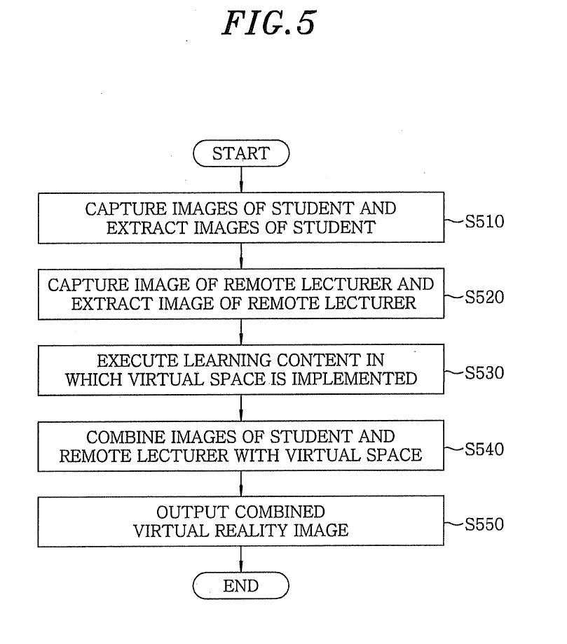

FIG. 5 is a flow chart showing an educational method using virtual reality in accordance with an embodiment of the present invention.

First, each student in a classroom is captured and an image of the student is extracted at step S510. A remote lecturer is captured and an image of the remote lecturer is extracted in step S520. Next, learning content in which a virtual space is implemented is executed in step S530, the images of the student and the remote lecturer are combined with the virtual space of the learning content in step S540, and an image of the combined virtual reality is output at step S550.

The embodiment including an audio system may be configured to receive the voices of the student and the remote lecturer, mix voices contained in the learning content with the voices of the student and the remote lecturer, and output the mixed voice. Here, the embodiment is implemented such that a remote lecturer computer processes the voice of the remote lecturer and the classroom lecturer computer processes the voice of the student.

Further, modules, function blocks or means according to the present embodiment may be implemented using various well-known devices such as electronic circuits, integrated circuits (ICs), or Application Specific Integrated Circuits (ASICs), and may be implemented as individual components. Further, as an alternative, two or more components may be integrated into a single component.

While the invention has been shown and described with respect to the embodiments, it will be understood by those skilled in the art that various changes and modification may be made without departing from the scope of the invention as defined in the following claims.

What is claimed is:

1. An educational system using virtual reality, comprising:
an image computer for extracting an image of a student from an entire image acquired by capturing the student;
a remote lecturer computer for extracting an image of a lecturer at a remote place from an entire image acquired by capturing the remote lecturer;
a classroom lecturer computer for executing learning content in which a virtual space is implemented, and performing real-time communication with the remote lecturer computer; and
a virtual reality computer for combining the image of the student and the image of the remote lecturer with the virtual space of the learning content.

2. The educational system of claim 1, further comprising:
a student microphone for receiving a voice of the student; and
a remote lecturer microphone for receiving a voice of the remote lecturer,
wherein the remote lecturer computer processes the voice of the remote lecturer, and the classroom lecturer computer processes the voice of the student.

3. The educational system of claim 1, further comprising:
a sound mixer for mixing voices contained in the learning content, the voice of the student and the voice of the remote lecturer with each other; and
a classroom speaker for outputting the mixed voice.

4. The educational system of claim 1, further comprising a monitoring camera for capturing a learning scene in the classroom,
wherein the remote lecturer computer outputs an image of the learning scene in the classroom.

5. The educational system of claim 1, further comprising:
a blue carpet used as a background of the student and configured to facilitate the extraction of the image of the student; and
a blue screen used as a background of the remote lecturer and configured to facilitate the extraction of the image of the remote lecturer.

6. The educational system of claim 1, wherein:
each of the student camera and the image computer is configured such that two or more cameras and two or more image computers are used to acquire a stereo image of the student;
the learning content is three-dimensional learning content; and
the virtual reality computer combines images contained in the three-dimensional learning content with the stereo image of the student, thus generating a three-dimensional image.

7. The educational system of claim 1, wherein the image computer recognizes and processes gestures of the student by estimating locations of one or more of hands, feet and head of the student.

8. The educational system of claim 7, wherein the estimation of the locations is performed using information about one or more of color and motion of the image of the student.

9. The educational system of claim 1, wherein the virtual reality computer aligns a bottom of a real world with a bottom of a virtual world using relative locations of the virtual space of the learning content, the image of the student and the image of the remote lecturer before combining the images with each other.

10. The educational system of claim 1, further comprising:
a projector for outputting the combined image; and
a classroom screen for displaying the image outputted from the projector.

11. An educational method using virtual reality, comprising:
extracting an image of a student from an entire image acquired by capturing the student;
extracting an image of a lecturer at a remote place from an entire image acquired by capturing the remote lecturer;
executing learning content in which a virtual space is implemented, and performing real-time communication with the remote lecturer; and
combining the image of the student and the image of the remote lecturer with the virtual space of the learning content.

12. The educational method of claim 11, further comprising:
receiving a voice of the student;
receiving a voice of the remote lecturer;
processing the voice of the remote lecturer; and
processing the voice of the student.

13. The educational method of claim 11, further comprising:
mixing voices contained in the learning content, a voice of the student and a voice of the remote lecturer with each other; and
outputting the mixed voice.

14. The educational method of claim 11, further comprising:
capturing a learning scene in the classroom; and
allowing an image of the learning scene in the classroom to be displayed at the remote place.

15. The educational method of claim 11, further comprising:
facilitating the extraction of the image of the student by using a blue carpet; and
facilitating the extraction of the image of the remote lecturer by using a blue screen.

16. The educational method of claim 11, wherein:
the extracted image of the student is a stereoscopic image;
the learning content is three-dimensional learning content; and
images contained in the three-dimensional learning content are combined with the stereoscopic image of the student to generate a three-dimensional image.

17. The educational method of claim 11, wherein gestures of the student are recognized and processed by estimating locations of one or more of hands, feet and head of the student.

18. The educational method of claim 17, wherein the estimation of the locations is performed using information about one or more of color and motion of the image of the student.

19. The educational method of claim 11, wherein, before combining the images, a bottom of a real world is aligned with a bottom of a virtual world using relative locations of the virtual space of the learning content, the image of the student and the image of the remote lecturer.

20. The educational method of claim 11, further comprising:
outputting the combined image; and
displaying the outputted image.
